(19) United States
(12) Patent Application Publication
(10) Pub. No.: US 2007/0165008 A1
(43) Pub. Date: Jul. 19, 2007

(54) Compact infrared touch screen apparatus

(75) Inventor: Timothy W. Crockett, Raleigh, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/334,149

(22) Filed: Jan. 17, 2006

(51) Int. Cl. G06F 3/042

(52) U.S. Cl. 345/175

(57) ABSTRACT

An infrared touch screen apparatus includes a display screen mounted within a frame, a circuit board disposed behind a back side of the display screen, an infrared transmitting device mounted on the circuit board and an infrared receiving device mounted on the circuit board. A first reflective device is in optical communication with the infrared transmitting device, said first reflective device configured to redirect an infrared beam originating from the infrared transmitting device behind the display screen, over a front side of said display screen. A second reflective device is in optical communication with the first reflective device, the second reflective device configured to redirect the infrared beam from the front side of said display screen to the infrared detecting device behind the display screen.

### BACKGROUND

The present invention relates generally to touch screen displays, and, more particularly, to a compact, infrared (IR) touch screen apparatus.

Touch screens are natural operator input partners for flat panel displays. Their negligible size, reliability and ease of use make them ideal complements for flat panel display systems. A variety of touch screen technologies are presently in existence including, for example, resistive technology, Near Field Imaging (NFI) technology, Surface Acoustical Wave (SAW) technology, capacitive technology and infrared (IR) technology.

In the case of IR touch screen technology, infrared emitter-collector pairs are used to project an invisible grid of light a small distance over the surface of the screen. When a beam(s) is interrupted, the absence of the signal at the collector is detected and converted to an X/Y touch coordinate. Since the method of determining a touch is optical instead of electrical or mechanical, IR touch screens are not as sensitive to damage as some technologies, such as resistive and capacitive technologies.

In addition, an IR touch ring is a frame shaped portion of circuit board used to surround the display in order to create the intersecting array of IR beams. A conventional touch ring surrounding a touch system typically requires a minimum width of about 2 to 3 centimeters, thereby forcing a designer to create a wide frame around the display. In the thin touch ring design, the touch controller circuitry is too bulky to be included on the touch ring printed circuit board (PCB), and is thus mounted on another PCB behind the display. An interface between the touch controller circuitry and the touch ring is typically implemented through a cable and associated connector, which in turn leads to serviceability and reliability problems.

Moreover, the size and shape of a touch ring is expensive and wasteful to manufacture, since a one-piece touch ring created from a large PCB wastes over 60% of the material due to the bulk of the board being cut away to form the frame-like shape that surrounds the display. Conversely, multiple piece touch rings require the presence of connectors between the individual parts, thereby creating reliability problems as well. Accordingly, it would be desirable to be able to eliminate the need for a touch ring circuit board and thus reduce the frame size of a touch screen device.

### SUMMARY

The foregoing discussed drawbacks and deficiencies of the prior art are overcome or alleviated by an infrared touch screen apparatus including a display screen mounted within a frame, a circuit board disposed behind a back side of the display screen, an infrared transmitting device mounted on the circuit board and an infrared receiving device mounted on the circuit board. A first reflective device is in optical communication with the infrared transmitting device, said first reflective device configured to redirect an infrared beam originating from the infrared transmitting device behind the display screen, over a front side of said display screen. A second reflective device is in optical communication with the first reflective device, the second reflective device configured to redirect the infrared beam from the front side of said display screen to the infrared detecting device behind the display screen.

In another embodiment, an infrared touch screen apparatus includes a display screen mounted within a frame, a circuit board disposed behind a back side of the display screen, an array of infrared transmitting devices mounted on the circuit board and a corresponding array of infrared receiving devices mounted on the circuit board. An array of first periscope devices is in optical communication with the infrared transmitting devices, the first periscope devices each configured to redirect an infrared beam originating from one of the infrared transmitting devices behind the display screen, over a front side of the display screen. An array of second periscope devices is in optical communication with the first periscope devices, the second periscope devices each configured to redirect the infrared beam from the front side of the display screen to the infrared detecting devices behind the display screen, thereby resulting in a grid of infrared light projected over the front side of the display screen.

### BRIEF DESCRIPTION OF THE DRAWINGS

Referring to the exemplary drawings wherein like elements are numbered alike in the several Figures:

FIG. 1 is a side cross sectional view of a conventionally configured IR touch screen apparatus;

FIG. 2 is a top down view of the conventionally configured IR touch screen apparatus of FIG. 1;

FIG. 3 is a side cross sectional view of an IR touch screen apparatus, in accordance with an embodiment of the invention;

FIG. 4 is a top down view of the IR touch screen apparatus of FIG. 3; and

FIG. 5 is a side cross sectional view of an alternative embodiment of the IR touch screen apparatus of FIG. 3.

### DETAILED DESCRIPTION

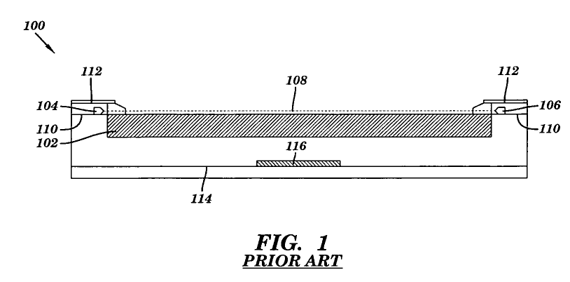

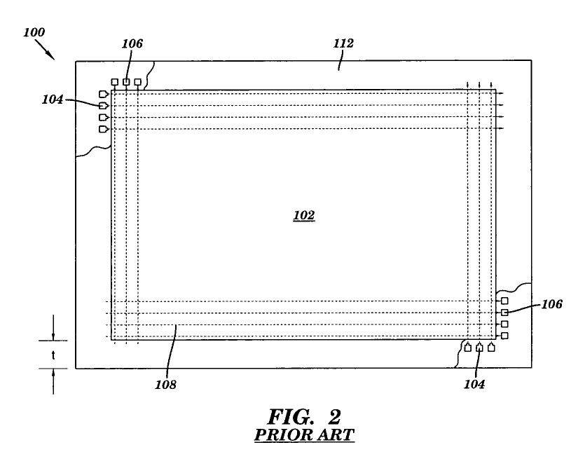

Referring initially to FIGS. 1 and 2, there is shown a side cross sectional view and a top down view, respectively, of a conventionally configured IR touch screen apparatus 100. As is shown, the apparatus 100 includes a display screen 102 (e.g., an LCD screen) across which a grid of infrared light is projected by means of a plurality of transmitting, light emitting diodes (LEDs) 104 and corresponding receiving phototransistors 106. In a conventional configuration, each infrared beam 108 is transmitted and received within the same plane (which is located slightly above the top surface of the display screen 102), meaning that the transmitting LEDs 104 and receiving phototransistors are side looking components. Such components are generally more expensive than more common LEDs and phototransistors that are mounted (more conventionally). Moreover, as is also shown in FIGS. 1 and 2, both the LED components 104 and the phototransistor components 106 are affixed to a frame-shaped circuit board 110 that surrounds the perimeter of the display screen 102. Further, the width of the circuit board 110 adds to the overall thickness, t, of the outer frame 112 of the touch screen apparatus as best seen in FIG. 2.

Notwithstanding the presence of circuit board 110, a separate circuit board 114 disposed behind the display 102 (FIG. 1) is still needed in order to support the control circuitry 116 thereon. Otherwise, the location of the control circuitry 116 on circuit board 110 would result in an even thicker (and less desirable) frame 112 around the display screen 102.

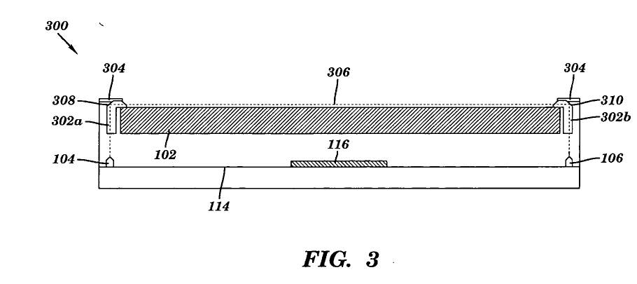

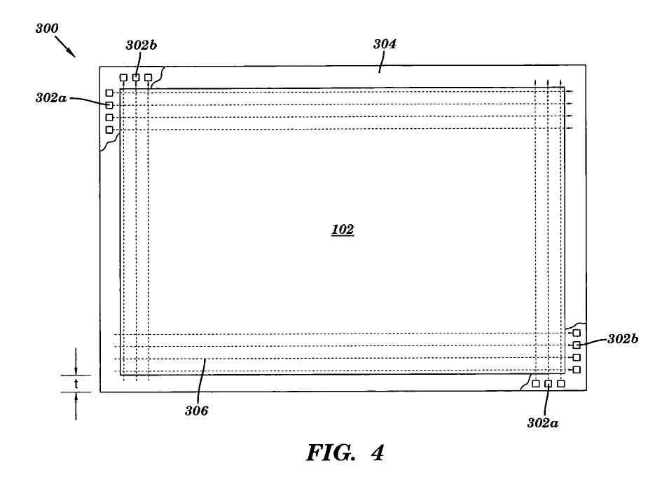

Therefore, in accordance with an embodiment of the invention, FIGS. 3 and 4 illustrate an IR touch screen apparatus 300, in accordance with an embodiment of the invention. In the present approach, the beginning and end points of the IR beams are located below the outer surface of the touch screen 102, and thus the beam paths occupy more than one plane. In this manner, the need for a frame-shaped circuit board around the display screen perimeter is eliminated, since the LEDs and phototransistors may be mounted behind the display screen on the same circuit board as the control circuitry.

In order to direct the IR beams from behind the top surface of the display 102, infrared reflection devices (also referred to herein as “periscopes”) are disposed within the frame 304 of the touch screen apparatus 300. In the embodiments depicted in FIGS. 3 and 4, the periscopes include an IR transparent material with sufficient density to cause total internal reflection. However, in lieu of total internal reflection devices, simple reflecting devices (e.g., mirrors) could also be used. As particularly shown in FIG. 3, a beam 306 transmitted from the LED 104 is directed through a first periscope 302a, where an internal reflective surface 308 therein redirects the beam 306 by substantially a 90-degree angle over the top surface of the display screen 102. The beam is then received by a second periscope 302b, where an internal reflective surface 310 therein redirects the beam by substantially a 90-degree angle orthogonal to the plane of the screen 102. The beam 306 is then detected by phototransistor 106. It is noted that in the embodiment of FIG. 3, the LED 104 and phototransistor 106 are mounted in an upward looking configuration (i.e., the optical center axis is orthogonal to the circuit board 114), which also eliminates the need for less common components such as side looking LEDs.

As more particularly illustrated in FIG. 4, the space savings realized by the elimination of the touch ring circuit board is reflected by the reduced thickness, t, of the frame 304. It will be appreciated, however, that the relative dimensions of the frame 304, display screen 102 and other components of apparatus 300 are not necessarily shown to scale with respect to one another, but rather are used for comparison purposes to illustrate the advantages of eliminating the touch ring circuit board by using the reflecting periscopes.

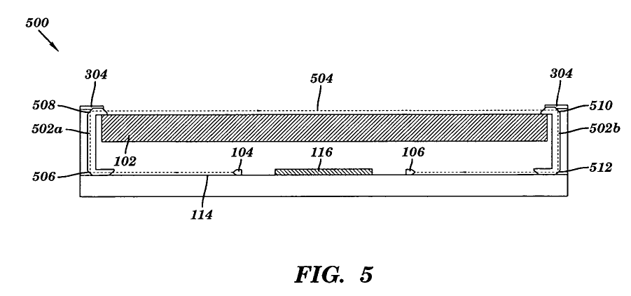

Finally, FIG. 5 is a side cross sectional view of an alternative embodiment of the IR touch screen apparatus of FIG. 3. As is shown, apparatus 500 utilizes periscopes (e.g., 502a, 502b) having more than one internally reflective surface. In this configuration, side looking optical components may be used as in the case of the more conventional assembly of FIG. 1. However, the LEDs 104 and phototransistors 106 are still mounted on circuit board 114 behind the back surface of the display screen 102 so as to reduce the minimum width of the frame 304. A beam 504 is emitted from LED 104 in a direction parallel to the plane of the front surface of the display screen 102, and reflected off a first reflective surface 506 of periscope 502a. This changes the direction of the beam 504 to be orthogonal to the plane of the display screen until it is then reflected of a second reflective surface 508 of periscope 502a.

As a result of this second directional change, the beam 504 now travels over the top of the LCD screen 102 where it is deflected by a first reflective surface 510 of periscope 502b in a downward orthogonal direction with respect to the top surface of the display screen 102. Finally, the beam 504 is deflected by a second reflective surface 512 of periscope 502b and received at phototransistor 106.

Although not specifically shown in the figures, a combination of the embodiments of FIGS. 3 and 5 could also be incorporated. For instance, upward looking LEDs could be used with a single reflecting periscope (as in FIG. 3), while a side looking phototransistor and double reflecting periscope (as in FIG. 5) could be used to receive the IR beam.

It will thus be appreciated that by configuring an IR touch screen apparatus with reflecting periscope devices, the optical path of the IR beams of the grid need not be confined to a plane above the front surface of the display screen. Because the board mounted optical components can in turn be located behind the display screen instead of along the periphery of the screen, the resulting minimum outer frame width is essentially limited only by the dimensions of the periscope devices. Furthermore, since a touch ring circuit board need not be manufactured to mount the LEDs and phototransistors thereupon, the unnecessary waste of discarded circuit board material is avoided.

It should also be appreciated that although the above described embodiments are presented in terms of single LED/transistor pairings, an IR grid is not necessarily limited to a single detector path. In other words, the reflective devices disclosed herein for eliminating touch ring circuit boards can also be applied to IR touch screens in which resolution is increased (without adding more optical pairs) by allowing an IR beam emitted from an LED to be detected by its corresponding center-aligned phototransistor, as well as by the near neighbor transistors. Moreover, a single phototransistor may be configured to detect IR beams emitted by its corresponding center-aligned LED as well as its near neighbors, thereby utilizing optical paths on and off of a simple X/Y orthogonal grid.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An infrared touch screen apparatus, comprising:
a display screen mounted within a frame;
a circuit board disposed behind a back side of said display screen;
an infrared transmitting device mounted on said circuit board and an infrared receiving device mounted on said circuit board;
a first reflective device in optical communication with said infrared transmitting device, said first reflective device configured to redirect an infrared beam originating from said infrared transmitting device behind said display screen, over a front side of said display screen; and
a second reflective device in optical communication with said first reflective device, said second reflective device configured to redirect said infrared beam from said front side of said display screen to said infrared detecting device behind said display screen.

2. The apparatus of claim 1, wherein said infrared transmitting device is mounted on said circuit board so as to transmit said infrared beam in an initial upward direction with respect to said circuit board.

3. The apparatus of claim 2, wherein said infrared receiving device is mounted on said circuit board so as to receive said infrared beam in downward direction with respect to said circuit board.

4. The apparatus of claim 1, wherein said first and second reflective devices further comprise total internal reflection periscope devices.

5. The apparatus of claim 4, wherein:
said infrared transmitting device is side mounted on said circuit board; and
said first periscope device includes a first reflective surface configured to deflect said beam transmitted from said infrared transmitting device in an upward direction with respect to said circuit board, and said first periscope device includes a second reflective surface configured to deflect said beam from said upward direction over said front side of said display screen.

6. The apparatus of claim 5, wherein:
said infrared receiving device is side mounted on said circuit board; and
said second periscope device includes a first reflective surface configured to redirect said infrared beam from said front side of said display screen in a downward direction with respect to said circuit board, and said second periscope device includes a second reflective surface configured to deflect said beam from said downward direction to said infrared receiving device.

7. An infrared touch screen apparatus, comprising:
a display screen mounted within a frame;
a circuit board disposed behind a back side of said display screen;
an array of infrared transmitting devices mounted on said circuit board and a corresponding array of infrared receiving devices mounted on said circuit board;
an array of first periscope devices in optical communication with said infrared transmitting devices, said first periscope devices each configured to redirect an infrared beam originating from one of said infrared transmitting devices behind said display screen, over a front side of said display screen; and
an array of second periscope devices in optical communication with said first periscope devices, said second periscope devices each configured to redirect said infrared beam from said front side of said display screen to said infrared detecting devices behind said display screen, thereby resulting in a grid of infrared light projected over said front side of said display screen.

8. The apparatus of claim 7, wherein said infrared transmitting devices are mounted on said circuit board so as to transmit an infrared beam in an initial upward direction with respect to said circuit board.

9. The apparatus of claim 8, wherein said infrared receiving devices are mounted on said circuit board so as to receive an infrared beam in downward direction with respect to said circuit board.

10. The apparatus of claim 7, wherein:
said infrared transmitting devices are side mounted on said circuit board; and
said first periscope devices include a first reflective surface configured to deflect said beam transmitted from said infrared transmitting devices in an upward direction with respect to said circuit board, and said first periscope devices include a second reflective surface configured to deflect said beam from said upward direction over said front side of said display screen.

11. The apparatus of claim 9, wherein:
said infrared receiving devices are side mounted on said circuit board; and
said second periscope devices include a first reflective surface configured to redirect said infrared beam from said front side of said display screen in a downward direction with respect to said circuit board, and said second periscope devices include a second reflective surface configured to deflect said beam from said downward direction to said infrared receiving device.
